(19) United States
(12) Patent Application Publication
(10) Pub. No.: US 2007/0030509 A1
(43) Pub. Date: Feb. 8, 2007

(54) System and method for performing selective off-loading of document processing operations

(75) Inventors: Manmohan Garg, Cerritos, CA (US); Ajit Sodhi, Irvine, CA (US); Andrey Savov, Fullerton, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Toshiba Corporation; Toshiba Tec Kabushiki Kaisha

(21) Appl. No.: 11/197,476

(22) Filed: Aug. 4, 2005

(51) Int. Cl. G06F 3/12

(52) U.S. Cl. 358/1.15; 358/403

(57) ABSTRACT

A system and method for selectively outsourcing document processing operations from a document processing device. The document processing device analyzes a submitted document processing job from a user and determines whether external devices are available and capable of performing some or all of the requested document processing operations. When external devices are available and capable, the document processing device performs any necessary local preprocessing and forwards information related to the document processing job to one of the external devices. The external device then processes the data and returns the processed data to the document processing device. The document processing device then performs any remaining document processing operations and the job is thereupon output according to the selected document processing operation.

### BACKGROUND

This invention is directed to a system and method for document processing operations. More particularly, this invention is directed to a system and method for performing selectively outsourced document processing from a document processing device.

Multifunction peripheral devices are being enhanced at an ever expanding rate to perform a greater number of services in addition to the basic scan, copy, facsimile, and print services. Present construction techniques of multifunction peripheral devices require that any service the device is to perform must be included during the initial build. This results in the multifunction peripheral device not being able to include a large number of high quality services due to processor/memory limitations. As newer and better document processing services become available, the multifunction peripheral device is quickly outdated and in need of replacement. Furthermore, when the user of a device has a better document processing service already licensed, that user cannot take advantage of such a service to make the multifunction peripheral device perform better.

Current trends in the document processing area indicate a move towards service oriented document processing where services are used by connecting to external systems on a network on a per use basis. Present multifunction peripheral devices are unable to effectively take advantage of services published on a network. Additionally, current devices are required to pack each service in each device instead of multiple devices in one location using a document processing service that saves system resources and licensing costs. The typical multifunction peripheral device is incapable of being enhanced to perform extended tasks, e.g., tasks other than that which the device was programmed to perform. For example, a scanning device cannot be extended to recognize the user name from the document itself and then file the document based on the user.

Thus there is a need for a system and method for performing selectively outsourced document processing from a document processing device.

### SUMMARY OF INVENTION

In accordance with the present invention, there is provided a system and method for document processing.

Still further, in accordance with the present invention, there is provided a system and method for selectively outsourcing document processing operations.

Still further, in accordance with the present invention, there is provided a system for performing selectively outsourced document processing from a document processing device. The system includes receiving means adapted to receive electronic document data. The receiving means include means adapted to receive a document processing request. The document processing request includes instruction data representing selected document processing to be performed on the received electronic document data. The system also includes communication means adapted to selectively communicate job data corresponding to the electronic document data and the instruction data to a second document processing device. The second document processing device processes the data in accordance with the document processing request. The receiving means further includes means adapted to receive processed job data from the second document processing device. The system further includes completion means adapted to complete, in accordance with the instruction data, at least one local document processing operation on the electronic document data.

Still further, in accordance with the present invention, there is provided a method for performing selectively outsourced document processing from a document processing device. The method begins by receiving electronic document data and a document processing request. The document processing request includes instruction data representing selected document processing to be performed on the received electronic document data. Job data, corresponding to the electronic document data and the instruction data, is then selectively communicated to a second document processing device for processing according to the document processing request. The processed job data is then received from the second document processing device and at least one local document processing operation is completed on the electronic document data.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description, serve to explain the principles of the invention.

FIG. 1 is a block diagram illustrating a system in accordance with the present invention;

FIG. 2 is a flow chart illustrating a token generation method in accordance with the present invention;

FIG. 3 is a flow chart illustrating an electronic document sharing method in accordance with the present invention.

### DETAILED DESCRIPTION OF THE EMBODIMENTS

The present invention is directed to a system and method for selectively outsourcing document processing operations. More particularly, the present invention is directed to a system and method for performing selectively outsourced document processing from a document processing device.

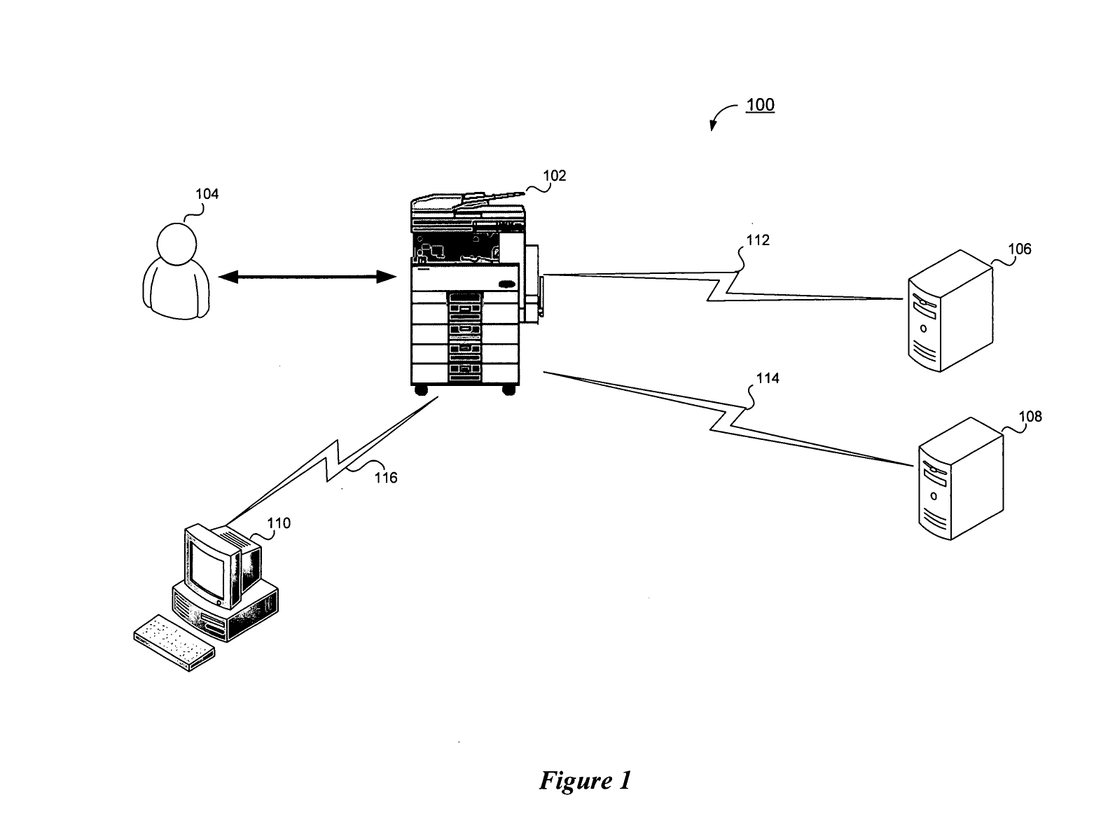

Turning now to FIG. 1, there is shown a diagram illustrating a system 100 in accordance with the present invention. As depicted in FIG. 1, a user 104 is provided access to a document processing device, shown in FIG. 1 as a multifunction peripheral device 102, for generating and processing image data. It will be appreciated by those skilled in the art that the document processing device is any suitable document processing device known in the art, including, without limitation, a facsimile machine, a scanning device, a printer, a copying device, a multifunction peripheral, and the like, or any combination thereof. Suitable commercially available document processing devices include, but are not limited to, the Toshiba e-Studio Series Controller.

The document processing device 102 is in data communication with one or more external document processing services or devices, illustrated in FIG. 1 as the external device 104 and the external device 106. It will be appreciated by those skilled in the art the present invention is capable of employing multiple external devices to provide enhanced document processing capabilities to the document processing device 102 and that the illustration of two such external devices in FIG. 1 is for example and not intended to limited the present invention thereto. The external devices 106, 108 are any electronic devices capable of performing document processing operations as are known in the art. For example, and without limitation, the external devices 106, 108 are capable of being multifunction peripheral devices, personal computers, servers, mainframes, printers, copiers, scanners, facsimile machines, and the like, or any combination thereof. In one embodiment of the present invention, the external devices 106 and 108 are communicatively coupled to a document processing services network (not shown). Such a network suitably tracks and monitors the usage of the external devices 106 and 108, and the costs associated therewith.

The document processing device 102 advantageously communicates with the external devices 106 and 108 via a corresponding communications link 112 and 114, respectively. As will be understood by those skilled in the art, the communications links 112 and 114 are any suitable means of communication between two electronic devices, including without limitation, the Internet, a Ethernet based local area network or wide area network connection, an infrared connection, a Bluetooth connection, a Wi-Fi connection, an IEEE802.11(x) connection, a telephonic connection, a cellular based connection, and the like, or a combination thereof. Preferably, the document processing device 102 communicates with the external devices 106 and 108 via the Internet. It will further be appreciated by those skilled in the art that although illustrated in FIG. 1 as being adjacent to each other, the external devices 106 and 108 need not be located in proximity, but rather, are capable of being located remote from each other as well as from the document processing device 102. As the skilled artisan will understand, when using the Internet for the communications channels 112 and 114, the external devices 106 and 108 need not be located in proximity to the document processing device 102. Preferably, the external devices 106 and 108 suitably notify, via the communications links 112 and 114, the document processing device 102 that the devices 106 and 108 are available for outsource processing of document data and whether the devices 106 and 108 are presently engaged, e.g., busy, or free to accept document processing requests.

The system 100 further includes a user device 110, illustrated in FIG. 1 as a personal computer. The skilled artisan will appreciate that for example purposes only, a desktop computer is shown as the user device 110. Other personal electronic devices, including without limitation, a laptop computer, a notebook computer, a tablet PC, a personal data assistant, a web-enabled cellular telephone, and the like, or any combination thereof, are equally capable of interacting with the document processing device 102 via the communications link 116. The communications link 116 is any suitable means of communication between two electronic devices, including without limitation, a Bluetooth connection, an Ethernet based connection, a wired or wireless network connection, an IEEE802.11(x) connection, an infrared connection, a cellular connection, and the like, or any combination thereof. In the preferred embodiment, the document processing device 102 is suitably equipped to communicate with the user device 110 via any means known in the art, as set forth above.

The document processing device 102 further includes a suitable user interface, incorporated thereon, that enables the user 104 to directly interface with the document processing device 102. In the preferred embodiment, the user interface of the document processing device 102 is any suitable interface known in the art, including, without limitation, a graphically based touch screen display, an LCD display with associated alpha-numeric keypad, and the like. The skilled artisan will appreciate that the user 104 is able to directly interact with the document processing device 102 to request the document processing device 102 to perform any of multiple document processing operations, for example and without limitation, scanning, facsimile, copying, printing, and the like, or any combination thereof.

In accordance with the present invention, the user 104 and the user device 110 are able to select one or more document processing operations to be performed by the document processing device 102. It will be appreciated that such selected document processing operations need not be inherently capable of being performed by the document processing device 102. When the document processing device 102 receives a document processing request that it cannot internally process, that would more effectively be processed by one of the external devices 106, 108, or where the processing of a portion or section of the document processing request would be more efficiently processed by one of the external devices 106, 108, the document processing device 102 first determines whether the desired external device is available, for example external device 106. The document processing device 102 is then able to accurately determine the workflow necessary for processing the requested document processing operation based upon the projected availability of the external device 106. When the external device 106 is available to receive processing requests, the document processing device 102 performs any preprocessing required and forwards the source address of the document data, the destination address of the processed data, and processing instructions to the external device 106 for outsource processing. It will be appreciated by those skilled in the art that the document data is suitably capable of comprising a complete electronic document, a portion of the electronic document, a section of the electronic document, and the like.

The external device 106 then retrieves document data from the source address and processes the data. When the external device 106 has completed the processing of the received document data in accordance with the instructions received from the document processing device 102, the external device 106 returns the processed data to the destination address specified in the document processing request. It will be understood by those skilled in the art that the processed data is suitably the complete electronic document, a section of the electronic document, a portion of the electronic document, and the like. The external device 106 then notifies the document processing device 102 of the completion of the requested operation. It will be appreciated by those skilled in the art that such a destination address is capable of being the document processing device 102, the external device 108, the user device 110, and the like.

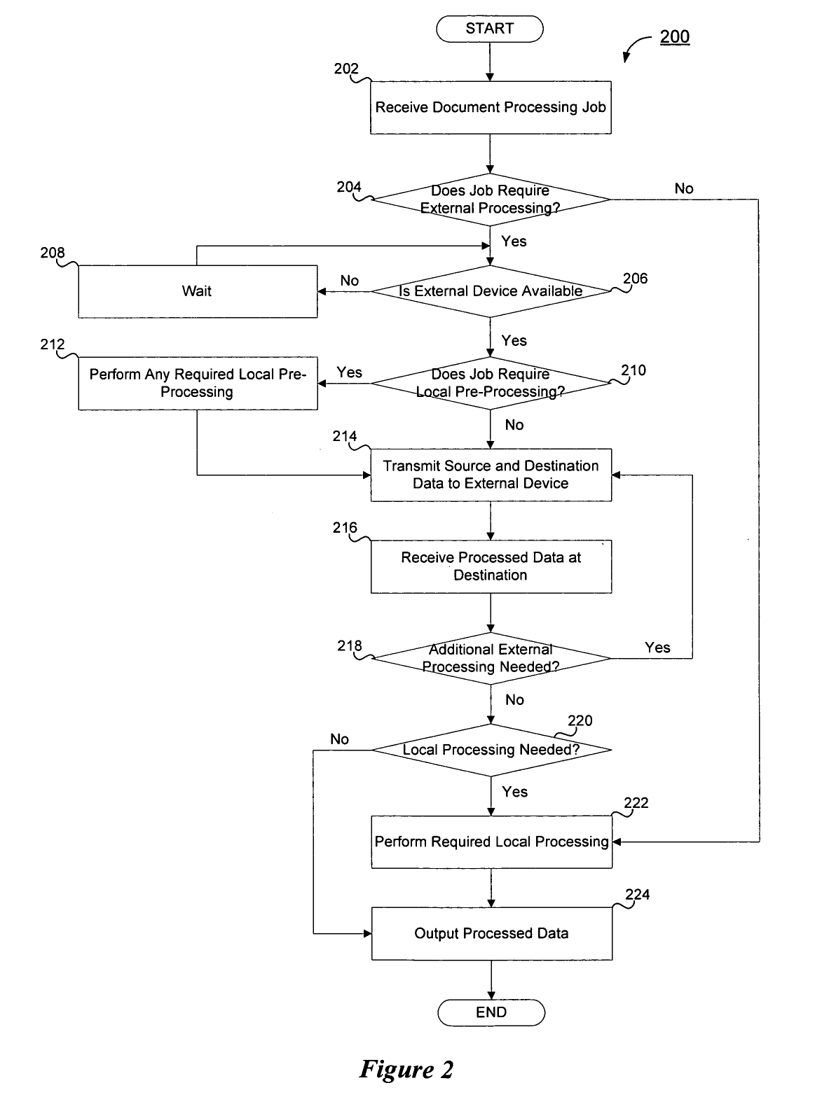

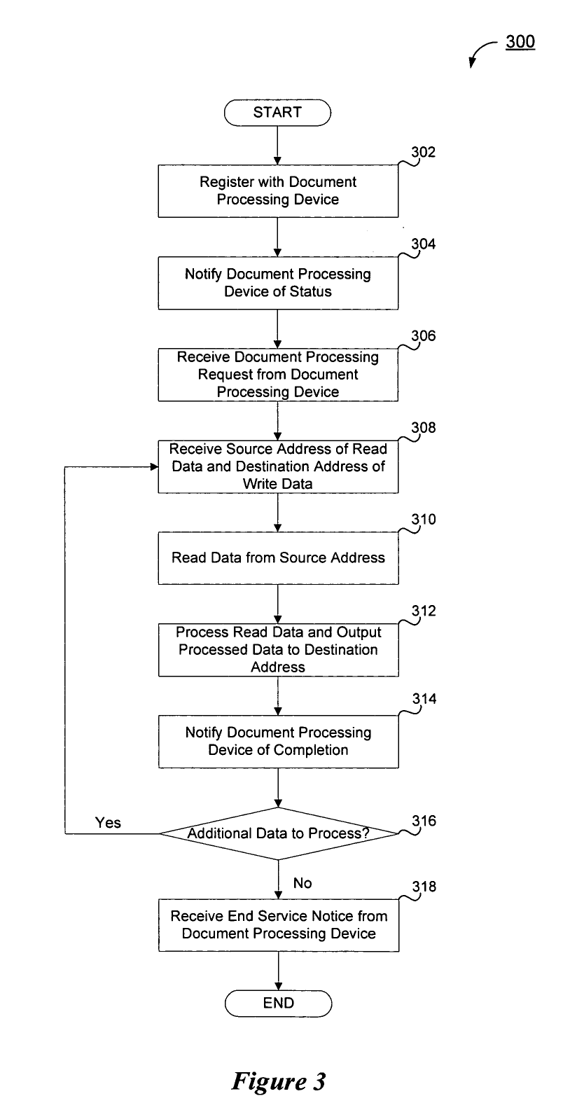

The document processing device 102 then analyzes the document processing request to determine whether additional processing operations are required to complete the user 104 specified document processing operation. The document processing device 102 also determines whether the additional processing operations need to be performed by the other external device 108, the document processing device 102 itself, or a combination thereof. Operation of the present system 100 will best be understood when viewed in conjunction with the flow charts of FIGS. 2 and 3, described below.

Turning now to FIG. 2, there is shown a flow chart 200 illustrating a method for performing document operations in accordance with the present invention. Beginning at step 202, the document processing device 102 receives a document processing request, also referred to herein as a document processing job, from the user 104 or the user device 110. As will be understood by those skilled in the art, the document processing job is any document or image processing operation known in the art and capable of being performed by an electronic device, for example and without limitation, scan to fax, scan to storage, copy, print, fax, print to file, and the like, or any combination thereof. The document processing device 102 then analyzes the received document processing job and determines at step 204 whether the requested job requires the use of at least one external device 106. It will be understood by those skilled in the art that the determination is capable of including a determination whether a portion of the job, such as a section of a document, a type of processing of the document, or a portion of the document, requires the use of at least one external device 106. When no external processing is required, flow proceeds to step 222, wherein the document processing device 102 performs the requested document processing operation locally. The processed data is then output at step 224 in accordance with the received document processing job. For example, when the document processing request is a copy request by the user 104, the document processing device 102 suitably performs the copy operation, as is known in the art, and outputs the selected number of copies on the user 104 selected medium.

When the document processing job requires an external device 106 to perform one or more document processing operations, flow proceeds to step 206, wherein a determination is made whether the external device 106 is available. It will be understood by those skilled in the art that the document processing device 102 is made aware of the capabilities and presence of the external devices 106 and 108 via the method described below with respect to FIG. 3. Thus, the document processing device 102 is aware of which of the available external devices 106 and 108 is capable of performing a portion or all of the requested document processing operation. When the document processing device 102 determines that the external device 106 is busy, i.e., unavailable, flow proceeds to step 208, wherein the document processing device 102 waits a predetermined period of time for the external device 106 to become available. When the external device 106 is available, flow proceeds to step 210, wherein a determination is made whether the document processing job requires any local preprocessing to be performed. It will be understood by those skilled in the art the document processing job is capable of requiring certain portions to be completed prior to processing by the external device 106. In such circumstances, the document processing device 102 performs any local preprocessing at step 212.

Following any required preprocessing, the document processing device 102 then transmits to the external device 106 the source address of the document data to be processed and the destination address of where the externally processed data is to be sent at step 214. It will be understood by the skilled artisan that the document data is suitably capable of comprising, but is not limited to, a portion of the document data, a section of the document, the complete document, and the like. Those skilled in the art will also appreciate that the external device 106 suitably retrieves the document data from the source address, processes the data in accordance with the document processing request, and writes the processed data to the destination address in accordance with the method described below with respect to FIG. 3. Upon receiving notification of the completion of the external processing, the document processing device 102 retrieves the processed data at step 216. A determination is then made at step 218 whether the document processing job requires any additional external processing.

When additional external processing is required, flow proceeds back to step 214 wherein the source address of the document data and the destination address for the processed data are forwarded to the available external device. For example, the external device 108 is then used to perform additional external processing of the data, leaving the external device 106 to perform document processing operations related to another document processing job. The external device 108 then processes the data in accordance with the method described in FIG. 3 below, and the document processing device 102 receives notification and the processed data at step 216. When no additional external processing is required at step 218, flow proceeds to step 220, wherein a determination is made whether local processing is required to complete the document processing job. When local processing is required, flow proceeds to step 222, wherein the document processing device 102 performs any remaining local document processing. The processed data is then output at step 224 in accordance with the received document processing request. When no local processing is required following the external processing, flow proceeds from step 220 to step 224, wherein the processed document data is output according to the instructions contained in the document processing request.

In accordance with the present invention, the document processing device 102 is suitably capable of outsourcing, to the external devices 106, 108, any portion, section, or the like to facilitate efficient processing of the selected document processing operation. It will be appreciated by those skilled in the art that the present invention is equally capable of outsourcing different portions or sections of the underlying electronic document to the external devices 106, 108 and then combine the processed data received into the processed underlying document. The skilled artisan will further appreciate that such outsourcing is capable of being performed simultaneously so that submitted document processing operations are not hindered by waiting for the external devices 106, 108 to complete document processing.

Referring now to FIG. 3 there is shown a flow chart 300 illustrating the method by which external devices 106 and 108 register with the document processing device 102 and process received document processing jobs. It will be understood by those skilled in the art that for purposes of explanation, registration and processing of a document processing job will be explained with respect to the external device 106 only. The skilled artisan will appreciate that the external device 108, and any other available external devices, perform similar registration and processing steps. Beginning at step 302, the external device 106 registers with the document processing device 102 via any means known in the art. Preferably, the external device 106 transmits notification to the document processing device 102 indicating the presence and the document processing capabilities of the external device 106. It will be understood by those skilled in the art that such notification is in any form capable of being transmitted and understood by the two devices 102 and 106.

Following registration, the external device 106 then notifies the document processing device 102 at step 304 of the external device 106 status. Preferably, the external device 106 informs the document processing device 102 that it is busy processing other jobs, is available to process a job, it is unavailable to process for a predetermined period of time while processing another job, it is down for maintenance, and the like. Continuing with the example above, the external device 106 has informed the document processing device 102 that it is available and receives, at step 306, a document processing request from the document processing device 102. At step 308, the external device 106 receives source address of read data, e.g., the document data, and the destination address of write data, e.g., the output processed document data.

The external device 106 then retrieves, from the source address, data representing the document upon which processing operations are to occur at step 310. It will be understood by those skilled in the art that the external device 106 suitably retrieves, via any means known in the art, document data stored at the address provided by the document processing device 102. Once retrieved the external device 106 processes the read data and outputs the processed data to the destination address at step 312. It will be appreciated by those skilled in the art that upon completion of the requested document processing operation, the external device 106 transmits the processed data to the destination address using any means known in the art. The external device 106 then notifies the document processing device 102 of the completion of the requested document processing operation at step 314.

At step 316, a determination is made whether additional data remains to be processed by the external device. For example, the document processing device 102 transmits a second document processing request to the external device 106, or alternatively, the originally received document processing request includes additional source and destination addresses, which require the external device 106 to perform additional document processing operations on the same data as set forth above. When additional data remains to be processed, flow proceeds from step 316 to step 308, wherein the source address and destination address of document data are received from the document processing device 102 and the external device processes the new data in accordance with the process described above with respect to steps 310-314. When no additional data remains to be processed at step 316, flow proceeds to step 318, wherein the external device 106 receives notification from the document processing device 102 to end service. It will be appreciated by those skilled in the art that such notification is accomplished using any means known in the art. In accordance with the present invention, the external devices 106 and 108 are capable of belonging to a document processing network, wherein each use of the external devices 106 and 108 incur a cost to the requesting user.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program, for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A system for performing selectively outsourced document processing from a document processing device comprising:
receiving means, the receiving means including means adapted for receiving electronic document data;
the receiving means further including means adapted for receiving a document processing request, which document processing request includes instruction data representative of selected document processing to be performed on received electronic document data;
communication means adapted for selectively communicating job data, corresponding to the electronic document data and instruction data, to a second document processing device for processing in accordance with the document processing request;
the receiving means further including means adapted for receiving processed job data from the second document processing device; and
means adapted for completing, in accordance with the instruction data, at least one local document processing operation on the electronic document data.

2. The system for performing outsourced document processing from a document processing device of claim 1 wherein a local document processing operation is performed prior to communication of job data to the second document processing device.

3. The system for performing outsourced document processing from a document processing device of claim 1 wherein a local document processing operation is performed after receipt of processed job data from the second document processing device.

4. The system for performing outsourced document processing from a document processing device of claim 2 wherein a local document processing operation is performed after receipt of processed job data from the second document processing device.

5. The system for performing outsourced document processing from a document processing device of claim 1 further comprising:
the communication means further including means adapted for selectively communicating job data corresponding to the electronic document data to a third associated document processing device for processing in accordance with the processing operation; and
means adapted for receiving processed job data from the third document processing device after processing thereof in accordance with the processing operation.

6. The system for performing outsourced document processing from a document processing device of claim 1 wherein the at least one local document processing operation includes at least one operation from the group consisting of printing, copying, scanning, faxing and e-mailing of electronic document data.

7. The system for performing outsourced document processing from a document processing device of claim 1 wherein the second document processing device further comprises means adapted for performing at least one operation from the group consisting of optical character recognition, storage, and format translation.

8. The system for performing outsourced document processing from a document processing device of claim 1 further comprising means adapted for communicating cost data representative of a cost associated with processing of the second document processing device.

9. A method for performing selectively outsourced document processing from a document processing device comprising the steps of:
receiving electronic document data;
receiving a document processing request, which document processing request includes instruction data representative of selected document processing to be performed on received electronic document data;
selectively communicating job data, corresponding to the electronic document data and instruction data, to a second document processing device for processing in accordance with the document processing request;
receiving processed job data from the second document processing device; and
completing, in accordance with the instruction data, at least one local document processing operation on the electronic document data.

10. The method for performing outsourced document processing from a document processing device of claim 9, further comprising the step of performing a local document processing operation prior to communication of job data to the second document processing device.

11. The method for performing outsourced document processing from a document processing device of claim 9, further comprising the step of performing a local document processing operation after receipt of processed job data from the second document processing device.

12. The method for performing outsourced document processing from a document processing device of claim 10, further comprising the step of performing a local document processing operation is performed after receipt of processed job data from the secondary device.

13. The method for performing outsourced document processing from a document processing device of claim 9 further comprising the steps of:
selectively communicating job data corresponding to the electronic document data to a third associated document processing device for processing in accordance with the processing operation; and
receiving processed job data from the third document processing device after processing thereof in accordance with the processing operation.

14. The method for performing outsourced document processing from a document processing device of claim 9 wherein the at least one local document processing operation includes at least one operation from the group consisting of printing, copying, scanning, faxing and e-mailing of electronic document data.

15. The method for performing outsourced document processing from a document processing device of claim 9 further comprising the step of performing, by the second document processing device, at least one operation from the group consisting of optical character recognition, storage, and format translation.

16. The method for performing outsourced document processing from a document processing device of claim 9 further comprising the step of communicating cost data representative of a cost associated with processing of the second document processing device.

17. A computer-readable medium of instructions with computer-readable instructions stored thereon for performing selectively outsourced document processing from a document processing device comprising:
instructions for receiving electronic document data;
instructions for receiving a document processing request, which document processing request includes instruction data representative of selected document processing to be performed on received electronic document data;
instructions for selectively communicating job data, corresponding to the electronic document data and instruction data, to a second document processing device for processing in accordance with the document processing request;
instructions for receiving processed job data from the second document processing device; and
instructions for completing, in accordance with the instruction data, at least one local document processing operation on the electronic document data.

18. The computer-readable medium of instructions with computer-readable instructions stored thereon for performing outsourced document processing from a document processing device of claim 17, further comprising instructions for performing a local document processing operation prior to communication of job data to the second document processing device.

19. The computer-readable medium of instructions with computer-readable instructions stored thereon for performing outsourced document processing from a document processing device of claim 17, further comprising instructions for performing a local document processing operation after receipt of processed job data from the second document processing device.

20. The computer-readable medium of instructions with computer-readable instructions stored thereon for performing outsourced document processing from a document processing device of claim 18, further comprising instructions for performing a local document processing operation is performed after receipt of processed job data from the secondary device.

21. The computer-readable medium of instructions with computer-readable instructions stored thereon for performing outsourced document processing from a document processing device of claim 17 further comprising:
instructions for selectively communicating job data corresponding to the electronic document data to a third associated document processing device for processing in accordance with the processing operation; and
instructions for receiving processed job data from the third document processing device after processing thereof in accordance with the processing operation.

22. The computer-readable medium of instructions with computer-readable instructions stored thereon for performing outsourced document processing from a document processing device of claim 17 wherein the at least one local document processing operation includes at least one operation from the group consisting of printing, copying, scanning, faxing and e-mailing of electronic document data.

23. The computer-readable medium of instructions with computer-readable instructions stored thereon for performing outsourced document processing from a document processing device of claim 17 further comprising instructions for performing, by the second document processing device, at least one operation from the group consisting of optical character recognition, storage, and format translation.

24. The computer-readable medium of instructions with computer-readable instructions stored thereon for performing outsourced document processing from a document processing device of claim 17 further comprising instructions for communicating cost data representative of a cost associated with processing of the second document processing device.

25. A computer-implemented method for performing selectively outsourced document processing from a document processing device comprising the steps of:
receiving electronic document data;
receiving a document processing request, which document processing request includes instruction data representative of selected document processing to be performed on received electronic document data;
selectively communicating job data, corresponding to the electronic document data and instruction data, to a second document processing device for processing in accordance with the document processing request;
receiving processed job data from the second document processing device; and
completing, in accordance with the instruction data, at least one local document processing operation on the electronic document data.

26. The computer-implemented method for performing outsourced document processing from a document processing device of claim 25, further comprising the step of performing a local document processing operation prior to communication of job data to the second document processing device.

27. The computer-implemented method for performing outsourced document processing from a document processing device of claim 25, further comprising the step of performing a local document processing operation after receipt of processed job data from the second document processing device.

28. The computer-implemented method for performing outsourced document processing from a document processing device of claim 26, further comprising the step of performing a local document processing operation is performed after receipt of processed job data from the secondary device.

29. The computer-implemented method for performing outsourced document processing from a document processing device of claim 25 further comprising the steps of:
selectively communicating job data corresponding to the electronic document data to a third associated document processing device for processing in accordance with the processing operation; and
receiving processed job data from the third document processing device after processing thereof in accordance with the processing operation.

30. The computer-implemented method for performing outsourced document processing from a document processing device of claim 25 wherein the at least one local document processing operation includes at least one operation from the group consisting of printing, copying, scanning, faxing and e-mailing of electronic document data.

31. The computer-implemented method for performing outsourced document processing from a document processing device of claim 25 further comprising the step of performing, by the second document processing device, at least one operation from the group consisting of optical character recognition, storage, and format translation.

32. The computer-implemented method for performing outsourced document processing from a document processing device of claim 25 further comprising the step of communicating cost data representative of a cost associated with processing of the second document processing device.
